(19) United States
(12) Patent Application Publication
(10) Pub. No.: US 2008/0225073 A1
(43) Pub. Date: Sep. 18, 2008

(54) Printing apparatus and method utilizing a table

(76) Inventors: Edward L. Feldhousen, Vancouver, WA (US); Trung Vu Nguyen, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/724,908

(22) Filed: Mar. 15, 2007

(51) Int. Cl. B41J 29/393

(52) U.S. Cl. 347/19

(57) ABSTRACT

A printing apparatus including: an imaging mechanism; a drum for advancing media sheets past the imaging mechanism for printing; an encoder coupled to the drum; a controller coupled to the encoder; and, a memory coupled to the controller and containing controller executable code and at least one table including a plurality of data entries each indicative of one of a plurality of sequential drum positions and at least one associated action; wherein, the controller executable code, when executed by the controller, causes the controller, for each data entry in the table, to: communicate data indicative of the indicated drum position to the encoder; receive an indication that the drum has rotated to the communicated drum position; responsively to the received indication, initiate the indicated associated action; and communicate data indicative of another of the data entries' associated drum position to the encoder responsively to the received indication.

### FIELD OF THE INVENTION

The invention relates generally to printing apparatus and related methods, and more particularly to print apparatus print sequencers and sequencing.

### BACKGROUND OF THE INVENTION

A printing apparatus, such as a computer printer, fax machine, copy machine or multi-function printing apparatus, typically includes an imaging mechanism for printing images on a substrate, such as a sheet of paper or a transparency, by way of non-limiting example only. A media sheet is typically picked from a stack stored in a tray for example, then moved along a media path, using a media handling system that includes motors and drive rollers. Each media sheet is advanced past the imaging mechanism to receive markings that form the printed images. In certain embodiments, the imaging mechanism includes an ink or toner cartridge or printhead, which forms character and/or graphic markings on the media sheet.

For drum based printing apparatus, the media handling system delivers media sheets to and receives media sheets from the drum. The drum advances received media sheets past the imaging mechanism and delivers marked media sheets to the media handling system for further processing and eventual output. In certain embodiments, each media sheet is fed to the rotating drum by a sheet feeder, and a vacuum captures it and rolls it on to the drum. Thus, drum based printing apparatus require specific printing operations to be sequenced as the drum rotates. Such operations include, for example, loading media, printing media, ejecting media, print carriage movement, height adjustment of the print carriages, firing pintheads, executing pen electrical tests and drum or media scanning.

### SUMMARY OF THE INVENTION

A printing apparatus including: an imaging mechanism; a drum for advancing media sheets past the imaging mechanism for printing; an encoder coupled to the drum; a controller coupled to the encoder; and, a memory coupled to the controller and containing controller executable code and at least one table including a plurality of data entries each indicative of one of a plurality of sequential drum positions and at least one associated action; wherein, the controller executable code, when executed by the controller, causes the controller, for each data entry in the table, to: communicate data indicative of the indicated drum position to the encoder; receive an indication that the drum has rotated to the communicated drum position; responsively to the received indication, initiate the indicated associated action; and communicate data indicative of another of the data entries' associated drum position to the encoder responsively to the received indication.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts and:

FIG. 1 illustrates a schematic view of a printing apparatus according to an embodiment of the present invention;

FIGS. 2a and 2b illustrate schematic views of a drum according to embodiments of the present invention;

FIG. 3 illustrates a schematic view of the encoder of FIG. 1 according to an embodiment of the present invention;

FIG. 4 illustrates a plurality of encoded drum positions according to an embodiment of the present invention; and,

FIGS. 5 and 6 illustrate a flow diagram of processes suitable for use with the apparatus of FIG. 1 and according to embodiments of the present invention.

### DETAILED DESCRIPTION OF THE PREFERRED EMBODIMENTS

The following description of the preferred embodiments is merely by way of example and is in no way intended to limit the invention, its application, or uses.

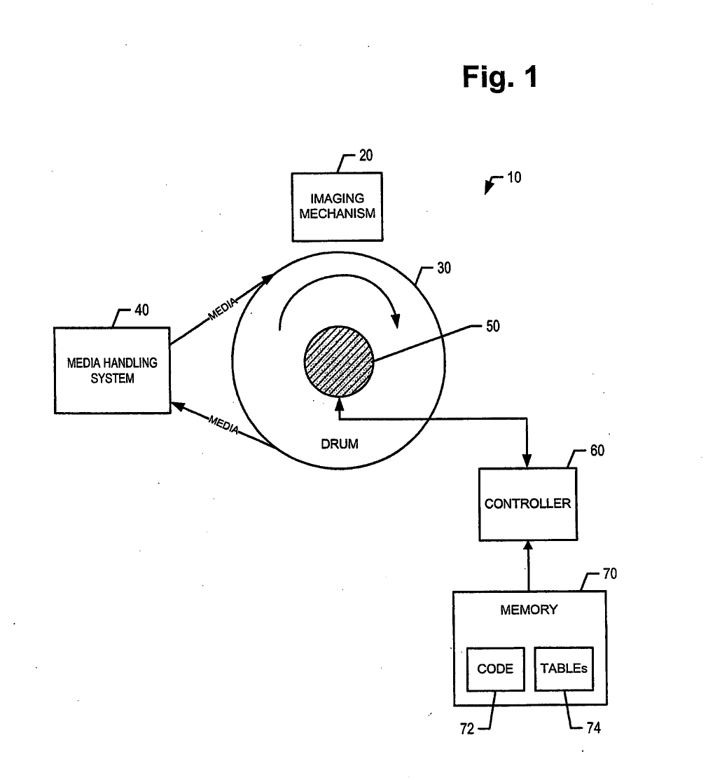

FIG. 1 shows a schematic view of a printing apparatus 10. Apparatus 10 may take the form of a printer suitable for use with one or more computing devices, a copier, a facsimile machine or a multifunction printing apparatus that incorporates printing/copying/faxing functionalities, all by way of non-limiting example. Apparatus 10 includes an imaging mechanism 20 for printing images on media sheets while they are supported by drum 30. The media sheets may take the form of sheets of paper, transparencies or any other substrate suitable for having images formed or marked thereon. Mechanism 20 may take the form of a monochrome and/or color printing mechanism, and incorporate one or more print cartridges (such as cartridges that incorporate ink or toner) and/or one or more print carriages that carry one or more printheads, such as ink-jet pen print bodies, all by way of non-limiting example only. In the illustrated embodiment, drum 30 rotates and advances or transports media sheets past imaging mechanism 20.

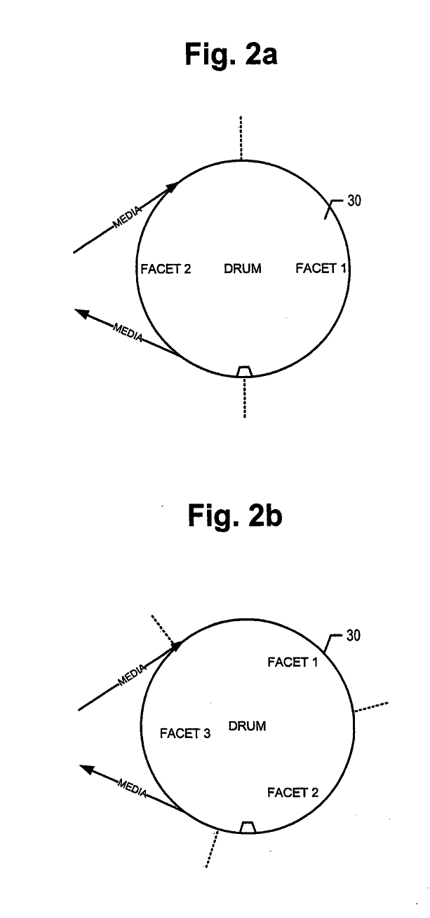

According to an embodiment of the present invention, drum 30 may be suitable for advancing media sheets of different sizes past imaging mechanism 20 in different modes. In such a case, drum 30 may be configured to have a different number of media sheet imaging facets in the different modes. Referring now also to FIGS. 2a and 2b, there are shown schematic views of a drum 30 in two different modes according to embodiments of the present invention. Drum 30 of FIG. 2a includes two imaging or printing facets, and is well suited for use where only two media sheets may be simultaneously engaged by drum 30. Drum 30 of FIG. 2b includes three imaging or printing facets, and is well suited for use where three media sheets may be simultaneously engaged by drum 30. Of course, other drum configurations may be used.

Referring again to FIG. 1, apparatus 10 includes a media handling system 40 that transports media sheets along a media path to drum 30, and in the illustrated embodiment, receives marked media sheets from drum 30. According to an embodiment of the present invention, media handling system 40 includes a plurality of drive rollers. Each drive roller may be akin to an elastomeric “tire”. Drive rollers may typically be grouped about rotating shafts, and each driven by a motor responsively to a controller 60. Controller 60 may take the form of or incorporate a printing event sequencer, for example. Print apparatus 10 may be configured to print single-sided media sheets in a simplex mode and/or double-sided media sheets in a duplex mode.

Controller 60 may typically take the form of a computing device that includes a processor. A processor generally includes a Central Processing Unit (CPU), such as a microprocessor. A CPU generally includes an arithmetic logic unit (ALU), which performs arithmetic and logical operations, and a control unit, which extracts instructions (e.g., code) from memory and decodes and executes them, calling on the ALU when necessary. Controller 60 may take the form of hardware, such as an Application Specific Integrated Circuit (ASIC) and or firmware, in addition to, or in lieu of, incorporating a processor.

The illustrated embodiment of the FIG. 1 includes a memory 70. Memory 70 stores data indicative of controller 70 executable code 72 and at least one table 74, containing a plurality of data entries. “Memory”, as used herein, generally refers to one or more devices capable of storing data, such as in the form of chips, tapes, disks or drives. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of further example only. Memory may take the form of internal or external disc drives, for example. Memory may be internal or external to an integrated unit including a processor. Memory preferably stores a computer program or code, e.g., a sequence of instructions being operable by a processor.

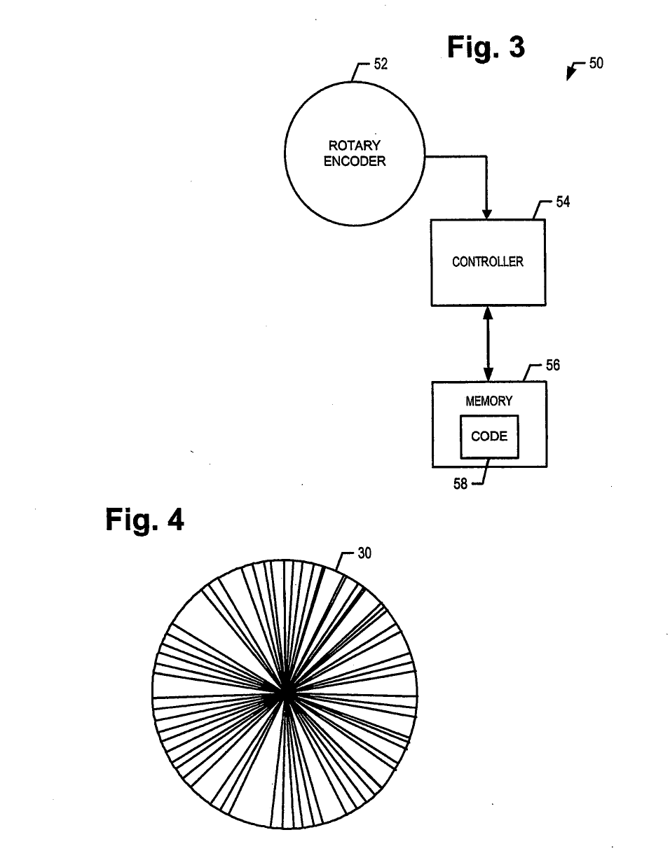

According to an embodiment of the present invention, apparatus 10 includes an encoder 50. Referring now also to FIG. 3, there is shown an embodiment of encoder 50 according to an embodiment of the present invention. The illustrated encoder 50 of FIG. 3 includes a rotary encoder 52. According to an embodiment of the present invention, rotary encoder 52 may be coupled to drum 30. According to an embodiment of the present invention, rotary encoder 52 may be coupled to a shaft that couples drum 30 to a drum motor. For non-limiting purposes of explanation only, a rotary encoder may typically take the form of an electro-mechanical and/or opto-mechanical device used to convert the angular position of a shaft or axle to a digital code. In the embodiment of FIG. 3, rotary encoder 52 converts the angular position of drum 30 to a digital code. Rotary encoder 52 may take the form of a conventional rotary encoder suitable for providing a signal indicative of the angular position of drum 30. According to an embodiment of the present invention, rotary encoder 52 may have a position encoding resolution sufficient to allow encoder 50 to provide position indication on the orderof about 1/7200^{th} inch of drum rotational travel. For example, rotary encoder 52 may have a physical resolution on the order of about 1/150th inch or about 1/300^{th} inch.

Referring now also to FIG. 4, there is shown a schematic view of various angular positions (shown as radial lines) that may be encoded by rotary encoder 52 according to an embodiment of the present invention. Of course, other positions may be encoded in lieu of or in addition to those shown in FIG. 4.

Referring again to FIG. 3, the illustrated embodiment of encoder 50 additionally includes a controller 54, coupled to a memory 56. Controller 54 may incorporate a processor that executes code, as discussed herein-above. Controller 54 may be embodied as firmware. Firmware, as used herein, generally refers to a combination of software and hardware. Alternatively, controller 54 may be embodied as an ASIC. Where controller 54 includes and/or executes a software component, it may be stored as code 58 in memory 56. According to an embodiment of the present invention, controller 54 and/or memory 56 may be in communication with controller 60.

Referring again to FIG. 1, as set forth memory 70 contains or stores at least one table 74 having data entries. According to an embodiment of the present invention, each data entry is indicative of a drum 30 position and at least one associated action, or event. According to an embodiment of the present invention, at least some of the actions or events have associated subroutines that may be executed by or at the request of controller 60 upon occurrence or detection thereof. According to an embodiment of the present invention, table 74 may include a separate table for each printing mode, e.g., for different sized media and/or color/monochrome.

Table-1 illustrates a non-limiting example of a table that may be stored in memory 70 as table 74. The embodiment of Table-1 is associated with an imaging mechanism 20 having two print carriages (C0, C1), each having three pens (P0, P1 and P2); and a drum 30 having three imaging facets (F0, F1 and F2). As will be recognized by those possessing an ordinary skill in the art, the illustrated embodiment of Table-1 shows print sequencing (PS) events.

TABLE 1

| Encoder | | Merge | Non- | Spin | Pen short test |
|---|---|---|---|---|---|
| Position | Event | Priority | skippable | offset | specification |
| 181266 | PS_F1_C1_P2_ENTER | 2 | true | 0 | {false, −1, −1, −1, −1} |
| 184866 | PS_F0_C1_P2_EXIT | 1 | true | 0 | {true, 1, 2, −1, 1} |
| 184866 | PS_F1_C1_MOVE | 1 | false | 0 | {false, −1, −1, −1, −1} |
| 184866 | PS_F0_EJECT | 1 | false | 0 | {false, −1, −1, −1, −1} |
| 197394 | PS_F2_C0_SWATH | 2 | false | 0 | {false, −1, −1, −1, −1} |
| 212844 | PS_F2_C0_P1_ENTER | 2 | true | 0 | {false, −1, −1, −1, −1} |
| 216444 | PS_F0_LOAD | 1 | false | −1 | {false, −1, −1, −1, −1}) |
| 223146 | PS_F2_C0_P2_ENTER | 2 | true | 0 | {false, −1, −1, −1, −1} |

The first data entry is associated with, and indicative of, drum 30 encoder 50 position 181266. The associated event or indicated action is to start printing (enter) for facet 1, pen carriage 1, pen 2. The second data entry is indicative of a position 184866, and to stop printing (exit) for facet 0, pen carriage 1, pen 2. The third data entry is also indicative of position 184866, and to move print carriage 1 during facet 1. The fourth data entry is also indicative of position 184866, and to eject media on facet 0. The fifth data entry is indicative of position 197394, and to prepare to print a swath on facet 2, print carriage 0. The sixth data entry is indicative of position 212844, and to start printing (enter) for facet 2, pen carriage 0, pen 1. The seventh data entry is indicative of position 216444, and to load media onto facet 0. The eighth data entry is indicative of position 223146, and to start printing (enter) for facet 2, pen carriage 0, pen 2.

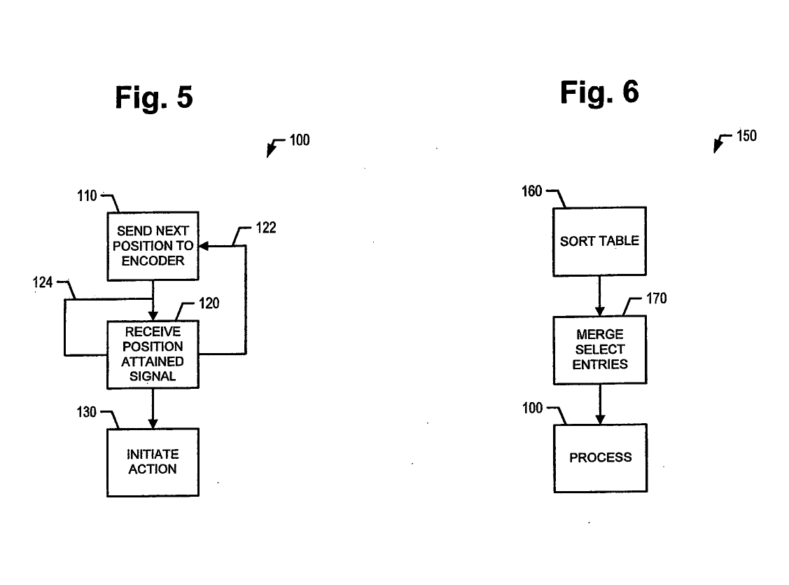

Referring now also to FIG. 5, there is shown a diagram view of a process 100 according to an embodiment of the present invention. According to an embodiment of the present invention, code 72 may include a portion that, when executed by controller 60, causes method 100 to be performed.

At block 110, controller 60 communicates encoder position 181266 (the first data entry indicative drum position) to encoder 50. This communication may be accomplished in any suitable manner, such as, by way of non-limiting example only: controller 60 signaling controller 54; or controller 60 storing the position in memory 70 and/or memory 56, and controller 54 retrieving it there from.

At block 120, encoder 50 notifies controller 60 that the previously communicated position 181266 has been reached. This notification may be accomplished in any suitable manner, such as, by way of non-limiting example only: controller 54 comparing rotary encoder 52 output to the position communicated at block 110, and signaling controller 60 that the previously communicated position has been reached when a match is determined.

Processing returns to block 110 (via flow 122), where the next trigger is set, by communicating position 184866 to encoder 50. Processing also continues to block 130. At block 130, controller 60 translates this notification to the event PS_F1_C1_P2_ENTER. In response to this translation, controller 60 performs a predetermined action associated with event PS_F1_C1_P2_ENTER. Responsively to detecting this event, processor 60 calls for a subroutine that, in the illustrated embodiment of Table-1, checks to see if there is any printing setup for facet 1, pen carriage 1, pen 2. For purposes of explanation, it may be assumed there is no printing on facet 1 at the moment, so no further action is taken for this notification.

Returning to block 120, encoder 50 notifies controller 60 that position 184866 has been reached. At block 130, controller 60 translates the second notification to event PS_F0_C1_P2_EXIT. In response to this event, controller 60 first sets up the next trigger. In this case, the next trigger is at the same encoder position (184866). So, instead of communicating a request to encoder 50, controller 60 instead sends itself a notification for the next trigger (via flow 124), event (PS_F1_C1_MOVE), which can then be processed by controller 60 without further delay after the current trigger is handled. Responsively to the translated event PS_F0_C1_P2_EXIT, controller 60 checks to see if there is any printing in progress for facet 0, carriage 1, pen 2. For non-limiting purposes of explanation, it may be assumed there is printing in progress for this pen, such that controller 60 instructs the pen module to stop printing and cleanup the pen.

Controller 60 receives the event notification it sent to itself for event PS_F1_C1_MOVE (via flow 124). In this case, there is a carriage move scheduled, so controller 60 instructs a carriage module to move carriage 1. Controller 60 then sets up the next trigger. Again, the next trigger is at the same encoder position (184866). Thus, controller 60 again sends itself a notification for the next trigger (via flow 124), event PS_F0_EJECT, which will then be processed without further delay after the current trigger is handled at block 120.

Controller 60 receives the event notification it sent to itself for event PS_F0_EJECT (via flow 124). In this case, there is an eject scheduled for facet 0, so controller 60 instructs drum 30 and/or media handling system 40 to eject the media on facet 0. In this case, the next trigger (position 197394) is not at the same encoder position, such that processing returns to block 110 and position 197394 communicated to encoder 50.

Again at block 120, encoder 50 notifies controller 60 that position 197394 has been reached. Processing returns to block 110, where controller 60 sets up the next trigger by communicating 212844 to encoder 50. Processing also continues to block 130, where controller 60 translates the received notification to event PS_F2_C0_SWATH. In response, controller 60 checks to see if there is any printing requested for facet 2, carriage 0. For purposes of explanation, it may be assumed there is printing scheduled on facet 2, carriage 0, such that controller 60 sets a logic state to indicate that it will be printing using this carriage.

At block 120, encoder 50 notifies controller 60 that position 212844 has been reached. Again, processing returns to block 110, where controller 60 sets up the next trigger by communicating 216444 to encoder 50. Again, processing also continues at block 130, where controller 60 translates this notification to event PS_F2_C0_P1_ENTER. In response to this event, controller 60 checks to see if there is any printing requested for facet 2, carriage 0, pen 1. For purposes of explanation, it may be assumed that there is printing scheduled for this pen, such that controller 60 instructs this pen to commence printing.

Again at block 120, encoder 50 notifies controller 60 that position 216444 has been reached. Again, processing returns to block 110, where controller 60 sets up the next trigger by communicating 223146 to encoder 50. Processing also continues to block 130, where controller 60 translates this notification to event PS_F0_LOAD. This causes controller 60 to see if there is a media load scheduled for facet 0. For purposes of explanation, it may be assumed there is a media load scheduled, such that controller 60 will request drum 30 and/or media handling system 40 to load media on facet 0.

Again at block 120, encoder 50 notifies controller 60 that position 223146 has been reached. Again, processing returns to block 110, where controller 60 sets up the next trigger. In this case, the end of the table has been reached, such that processing the beginning of the table occurs again and position 181266 is communicated to encoder 50. Processing also continues at block 130, where controller 60 translates this notification to event PS_F2_C0_P2_ENTER. In response to this event, controller 60 checks to see if there is any printing requested for facet 2, carriage 0, pen 2. For purposes of explanation, it may be assumed there is printing scheduled for this pen, and controller 60 instructs a pen module to start printing using this pen.

Processing of table 74 continues in such a manner as drum 30 rotates. According to an embodiment of the present invention, there may be a different table associated with each of a plurality of modes, and controller 60 may select one of the tables for use dependently upon what media type (e.g., size) is being used with the printing apparatus at that time.

According to an embodiment of the present invention, there are two types of events or actions: skippable and non-skippable. According to an embodiment of the present invention, the type of event (skippable or non-skippable) is designated in table 74. This is shown as the “non-skippable” true/false flag in Table-1. Skippable events are akin to master triggers—in that they are associated with high level external events. For example, a request to print on a certain carriage, or to load a media sheet. In general, skippable events are externally triggered, such as by a user's request to print or copy. In contrast, non-skippable events or triggers are lower level pieces that often relate to a high level command, such as to print using a first carriage. For example, they may be related to a position in which to start printing on a first pen versus a second pen versus a third pen in a given carriage. In such a case, these may be unique positions and only done once overall printing for that carriage with a skippable trigger has been indicated. According to an embodiment of the present invention, next trigger set up may occur after a skippable event is handled, but before a non-skippable event is handled. For non-limiting purposes of completeness, “skippable”, as used herein, is intended to designate that upon such a trigger being translated by controller 60, controller 60 may determine whether or not to carry out a certain action dependently upon a predetermined condition, which may be externally sourced, being present. If the condition is present, the action may be carried out. If the condition is not present, the action is skipped. Consistently, “non-skippable”, as used herein, refers to a trigger that automatically triggers an action upon translation of the event and a state of the printing apparatus (such as the state set in the discussion of Table-1 herein-above).

Some actions by their nature are better executed earlier than other actions associated with a given printing facet. For example, in order to print on a given facet, a media load event must occur first. Similarly, some events are better executed later than other events on the same printing facet. For example, media should not be ejected until printing is complete. Such information may be embodied in “spin offset” data, as is shown in Table-1. A spin offset field arises from the fact that encoder position numbers “wrap around” to zero every revolution, and may be stored in the merged and sorted table as a value from 0 to 274559. By storing values in this way, the apparatus may lose track of the need of events like load and eject to occur earlier or later. The spin offset field captures whether or not a trigger needs to be advanced a spin. For example, a trigger Facet 0_media sheet load may typically be advanced by a spin, so it has an offset value of −1. The spin offset field also captures whether or not a trigger needs to be delayed a spin. For example, a trigger Facet 1_media sheet eject may typically be delayed by a spin, so it has an offset value of +1. The final spin offset values may be computed during the trigger sorting process (block 160, FIG. 6).

According to an embodiment of the present invention, at least some of the actions or events may have additional associated data elements. These data elements may be used to trigger other events in the printing apparatus, such as via interrupt signaling at a hardware level. One example of such an event is an electrical pen test, where one or more pens are checked for a short-circuit condition, for example. Such data elements are shown in the non-limiting embodiment of Table-1, as “Pen short test specification”. In the illustrated embodiment of Table-1, each pen short test entry includes four data elements: 1) a true/false indication of whether or not this trigger is associated with a pen short test; 2&3) carriage and pen, where if this trigger is associated with a pen short test, carriage and pen store the carriage and pen to pass along with the request to other HW modules to perform the pen short test; 4) position, which stores a copy of the encoder position of this trigger so that it can be used to determine if a trigger being processed needs to be setup as a pen short trigger; and 5) a facet indicator, which stores the facet on which a given pen short test should be executed for the indicated carriage and pen.

Referring now also to FIG. 6, there is shown a diagram view of a process 150 according to an embodiment of the present invention. According to an embodiment of the present invention, code 72 may include a portion that, when executed by controller 60, causes method 150 to be performed. At block 160, controller 60 may sort the data entries in table 74. As is shown in Table-1, controller 60 may sort the entries by ascending value in the position field. Such a sorting organizes table 74 data entries in a drum rotational position sequential order.

By way of further non-limiting example only, Table-2 shows an exemplary embodiment of Table-1 prior to sorting at block 160, where 0≦x₁≦12,527, 0≦x₂≦12,527 and 0≦x₁+x₂≦12,527.

TABLE 2

| Encoder | | Merge | Non- | Spin | Pen short test |
|---|---|---|---|---|---|
| Position | Event | Priority | skippable | offset | specification |
| 216444 | PS_F0_LOAD | 1 | false | −1 | {false, −1, −1, −1, −1}) |
| 184866 | PS_F0_C1_P2_EXIT | 1 | true | 0 | {true, 1, 2, −1, 1} |
| 184866 + x₁ | PS_F1_C1_MOVE | 1 | false | 0 | {false, −1, −1, −1, −1} |
| 181266 | PS_F1_C1_P2_ENTER | 2 | true | 0 | {false, −1, −1, −1, −1} |
| 184866 + x₁ + x₂ | PS_F0_EJECT | 1 | false | 0 | {false, −1, −1, −1, −1} |
| 212844 | PS_F2_C0_P1_ENTER | 2 | true | 0 | {false, −1, −1, −1, −1} |
| 223146 | PS_F2_C0_P2_ENTER | 2 | true | 0 | {false, −1, −1, −1, −1} |

At block 160, controller 60 may use conventional processing techniques to reorder the data entries in Table-2 by ascending encoder position value, as is shown in Table-1. Processing then continues to block 170.

At block 170, controller 60 merges select ones of the sorted data entries. According to an embodiment of the present invention, controller 60 may compare adjacent entries in the sorted table 74, to determine if they should be merged. According to an embodiment of the present invention, controller 60 may compare the position field of adjacent entries in the sorted table 74, to determine if they should be made to be identical. According to an embodiment of the present invention, if the position values of two adjacent data entries in the sorted table 74 are within a predetermined threshold of one-another, the value of at least one of the position entries is changed. According to an embodiment of the present invention, the predetermined threshold may be about 756/7200^{th} (0.105) inches.

According to an embodiment of the present invention, entries be merged may be reordered according to a priority value. According to an embodiment of the present invention, the priority value may be indicative of the relative importance of the associated event being handled at precisely the associated encoder position. Such priority values are shown in Tables 1 and 2 as the “Merge Priority” field.

According to an embodiment of the present invention, if the position values of two adjacent data entries in the sorted table 74 are within a predetermined threshold of one-another, the value of at least one of the position entries is duplicated to the other of the entries. According to an embodiment of the present invention, if the position values of two adjacent data entries in the sorted table 74 are within a predetermined threshold of one-another, the value of the position of a first of the entries is duplicated to the value position of the other of the entries.

By way of further non-limiting example only, Table-3 shows an exemplary embodiment of Table-1 after sorting at block 160, and prior to merging at block 170, where 0≦x₁≦12,527, 0≦x₂≦12,527 and 0≦x₁+x₂≦12,527.

TABLE 3

| Encoder | | Merge | Non- | Spin | Pen short test |
|---|---|---|---|---|---|
| Position | Event | Priority | skippable | offset | specification |
| 181266 | PS_F1_C1_P2_ENTER | 2 | true | 0 | {false, −1, −1, −1, −1} |
| 184866 | PS_F0_C1_P2_EXIT | 1 | true | 0 | {true, 1, 2, −1, 1} |
| 184866 + x₁ | PS_F1_C1_MOVE | 1 | false | 0 | {false, −1, −1, −1, −1} |
| 184866 + x₁ + x₂ | PS_F0_EJECT | 1 | false | 0 | {false, −1, −1, −1, −1} |
| 197394 | PS_F2_C0_SWATH | 2 | false | 0 | {false, −1, −1, −1, −1} |
| 212844 | PS_F2_C0_P1_ENTER | 2 | true | 0 | {false, −1, −1, −1, −1} |
| 216444 | PS_F0_LOAD | 1 | false | −1 | {false, −1, −1, −1, −1}) |
| 223146 | PS_F2_C0_P2_ENTER | 2 | true | 0 | {false, −1, −1, −1, −1} |

At block 170, controller 60 first compares 181,266 to 184,866. In this exemplary embodiment it is assumed that the predetermined threshold is less than 3,600 (184,866-181,266), such that no entry merging occurs. Controller 60 then compares 184,866 to 184,866+x₁. In this exemplary embodiment it is assumed that x₁ is less than the predetermined threshold, such that 184,866 is duplicated to the third data entries' position value (as is shown in Table-1). Controller 60 then compares 184,866 (the new value in the third data entry) to 184,866+x₁+x₂. In this exemplary embodiment it is assumed that x₁+x₂ is still less than the predetermined threshold, such that 184,866 is duplicated to the fourth data entries' position value (as is shown in Table-1). For non-limiting purposes of explanation and completeness, it is assumed that 184,866+x₁+x₂ is not within the predetermined threshold of 197,394, and that no further merging of the subsequent entries occurs. This results in the configuration of Table-1.

Referring still to FIG. 5, processing then continues to block 100, where process 100 (FIG. 4) may be carried out.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus comprising:
an imaging mechanism;
a drum positioned relative to the imaging mechanism so as to advance media sheets past the imaging mechanism for marking by the imaging mechanism;
an encoder coupled to the drum;
a controller coupled to the encoder; and,
a memory coupled to the controller and containing controller executable code and at least one table including a plurality of data entries each indicative of: an associated one of a plurality of rotational positions of the drum, and at least one associated action;
wherein, the controller executable code, when executed by the controller, causes the controller, for at least some of the data entries in the at least one table, to:
communicate data indicative of the associated rotational drum position to the encoder;
receive an indication that the drum has rotated to the communicated drum position;
responsively to the received indication, initiate the associated action; and
responsively to the received indication, communicate data indicative of another of the data entries' associated rotational drum position to the encoder.

2. The apparatus of claim 1, wherein the controller executable code, when executed by the controller, further causes the controller to sort the data entries in the at least one table according to the associated drum positions.

3. The apparatus of claim 2, wherein the controller executable code, when executed by the controller, further causes the controller to automatically alter a data entry having an associated rotational drum position within a predetermined threshold of another data entry.

4. The apparatus of claim 3, wherein the altering is dependent upon the another data entry.

5. The apparatus of claim 4, wherein at least some of the data entries are further indicative of priority indications, and the altering is further dependent upon the priority indications.

6. The apparatus of claim 4, wherein the controller executable code, when executed by the controller, further initiates an action associated with another, altered data entry responsively to the received indication.

7. The apparatus of claim 1, wherein the imaging mechanism comprises a plurality of print carriages, each having an associated plurality of ink-jet pens.

8. The apparatus of claim 1, wherein the code for initiating an associated action comprises code for executing at least one sub-routine.

9. The apparatus of claim 1, wherein each data entry is further indicative of whether to trigger another event in the printing apparatus.

10. The apparatus of claim 9, wherein the triggering another event in the printing apparatus is via interrupt signaling.

11. The apparatus of claim 1, wherein the controller executable code, when executed by the controller, further causes wherein:
the at least one table comprises a plurality of tables, each associated with a different number of imaging facets on the drum; and,
the memory further comprises code for selecting one of the tables for processing.

12. The apparatus of claim 1, wherein the encoder comprises a rotary encoder.

13. The apparatus of claim 12, wherein the encoder further comprises a processor.

14. The apparatus of claim 12, wherein the rotary encoder can encode about 7200 distinct drum positions per inch.

15. A method for sequentially carrying out a plurality of actions for marking a media sheet using an apparatus including a drum that rotates through a plurality of positions to advance a media sheet past an imaging mechanism, comprising:
associating each of the actions with one of the drum positions;
altering at least some of the associated drum positions that are sufficiently adjacent others of the associated drum positions;
receiving notifications of the drum rotating to each of the associated drum positions; and,
carrying out each of the actions responsively to the received notification that the drum has rotated to the associated or altered position, respectively.

16. The method of claim 15, further comprising providing a data entry in a table for each action and associated drum position.

17. The method of claim 16, further comprising sorting the data entries by the associated drum positions.

18. The method of claim 17, further comprising communicating a next one of the sorted data entries to an encoder that provides the notifications responsively to receiving a notification that the drum has rotated to the associated position of a prior one of the data entries.
